(19) United States
(12) Patent Application Publication
(10) Pub. No.: US 2011/0269898 A1
(43) Pub. Date: Nov. 3, 2011

(54) METHOD FOR SYNTHESIZING IMPROVED BINDERS HAVING A DEFINED GRAIN SIZE DISTRIBUTION

(76) Inventors: Helmut Schwind, Hanau (DE); Uwe-Martin Wiesler, Darmstadt (DE); Cornelia Borgmann, Frankfurt (DE); Thomas Schmied, Luetzelbach (DE); Stefanie Maus, Frankfurt (DE); Sven Balk, Frankfurt (DE)

(21) Appl. No.: 13/142,508

(22) PCT Filed: Jan. 21, 2010
(86) PCT No.: PCT/EP2010/050655

§ 371 Date: Jun. 28, 2011

(30) Foreign Application Priority Data
Feb. 12, 2009 (DE) 10 2009 000 814.4

(51) Int. Cl. C09D 133/10; C09D 11/02; C09J 133/10; C08F 120/10

(52) U.S. Cl. 524/560; 526/329.7

(57) ABSTRACT

The invention relates to a method for producing polymers for paint applications by polymerizing esters of acrylic acid or of methacrylic acid or vinyl aromatic compounds or other radically polymerizable vinyl compounds or monomer mixtures that consist predominantly of such monomers by means of a continuous polymerization method. The invention relates in particular to a solvent-free, continuous method of producing polymers, whereby it is possible to produce binders for paint applications having an adjustable granule size. The polymer granulates produced according to the invention are characterized by superior processing properties without fine fractions.

### FIELD OF THE INVENTION

The invention relates to a process for the preparation of polymers for coating applications by polymerization of esters of acrylic acid or of methacrylic acid or of vinylaromatics or of other vinyl compounds capable of free radical polymerization or of monomer mixtures which predominantly comprise such monomers by means of a continuous polymerization process. In particular, the invention relates to a solvent-free, continuous process for the preparation of polymers, by means of which binders for coating applications with adjustable granule size can be prepared. The polymer granules prepared according to the invention are distinguished by improved processability without fine fractions.

### PRIOR ART

According to the prior art, (meth)acrylate or vinylaromatic binders for coating applications are prepared as a rule by means of suspension polymerization or solution polymerization. (Meth)acrylates are understood as meaning both acrylic acid and its derivatives, for example esters, and methacrylic acid and its derivatives, for example its esters, and mixtures of the abovementioned components.

The present invention on the other hand describes a continuous mass polymerization process. Such a process can be carried out without harmful solvents. During a polymerization, for example of (meth)acrylates, solvents can give rise to secondary reactions, such as chain-transfer reactions, undesired termination reactions or even polymer-analogous reactions. In addition, the handling of solvents under production conditions constitutes a safety risk. Furthermore, the choice of the solvent may also be limited by the production process—for example by the required reaction temperature. This in turn adversely affects the subsequent formulation and the application form, for example with regard to excessively long drying times because the solvent boils at too high a temperature.

An alternative removal of the solvent used for the production necessitates an additional, undesired production step and additionally pollutes the environment owing to the use of two different solvents for preparation and use. Moreover, solvent residues in the product interfere in the granulation, the extrusion, the formulation and the processing of the binder. In coating applications, these additional solvent constituents can furthermore impair the quality of the coating, for example with respect to gloss, pigmentation or weather stability.

The suspension polymerization of esters of acrylic acid or of methacrylic acid or vinylaromatics or of monomer mixtures which predominantly comprise such monomers is known in principle. This process, too, is carried out in the absence of a solvent. Compared with the mass polymerization, however, there is the major disadvantage that a large amount of water is used in this process. This necessitates additional process steps, such as filtration and subsequent drying. This drying generally takes place only incompletely. However, even low residual water contents lead to a substantial impairment of the optical properties, such as, for example, gloss or pigment dispersing, in coating applications.

A suspension polymerization, too, cannot be carried out continuously but only in batch operation. Such a process is less flexible and efficient to carry out compared with a continuous polymerization.

A further disadvantage of the suspension polymerization compared with other polymerization processes is the large number of auxiliaries, such as dispersants, emulsifiers, antifoams or other auxiliaries, which have to be used and are also still present in the end product after working-up. In a coating, these auxiliaries as an impurity can lead, for example, to reduced gloss, poorer dispersing of pigments or fish eyes due to insufficiently washed out dispersants insoluble in organic solvents. Another disadvantage is the very limited copolymerizability of polar comonomers, such as (meth)acrylic acids, aminofunctional or hydroxyfunctional (meth)acrylates. The proportion of these monomers in the respective monomer mixture must be greatly limited owing to their water solubility.

A further major disadvantage of the suspension polymerization is the required reaction temperature. Such a process can be carried out in only a very small temperature window. Temperatures above 100° C. are in principle difficult to establish owing to the water used. A theoretical procedure under pressure and at temperatures above 100° C. is not advisable owing to the additionally improved solubility of the monomers in the aqueous phase under such conditions. At temperatures which are too low, on the other hand, the suspension polymerization takes place only very slowly or incompletely and it is extremely difficult to establish a process-compatible particle size. An example of the preparation of suspension polymers as binders for coating applications is to be found in EP 0 190 433.

A further disadvantage of the suspension polymerization compared with the present invention is the particle size of the products. It is known to the person skilled in the art that suspension polymers occur in a particle size range from a few microns to not more than one centimetre. However, even large polymer beads additionally have a large proportion of fine particles. This fine fraction leads to some disadvantages of such a material. Firstly, these product fractions lead to problems in the purification, drying and packing of the material, including a danger of a fine dust explosion. Secondly, products having a relevant fine fraction cannot be used in an extrusion process. For feeding raw materials, most extruders require a minimum particle size optimum for this purpose. Another disadvantage is the frequently occurring nonuniformity of the particles, which, for example, lead to very different dissolution times in a dissolution process.

A further disadvantage of the suspension polymerization compared with the mass polymerization is the energy balance: the heating-up of about 50% of the aqueous phase and the cooling of this aqueous phase necessary after the polymerization are energy-consumptive and time-consuming.

The non-continuous mass polymerization in stirred vessels or tanks leads in principle only to incomplete reactions of the monomers and hence to high proportions of residual monomers, which in turn adversely affect the coating properties or have to be removed in a complicated manner prior to formulation. In addition, the granulation of the product must be effected in a separate process step and cannot be integrated into the production process.

A large number of different continuous mass polymerization methods for the preparation of poly(meth)acrylates is known to the person skilled in the art. EP 0 096 901 describes, for example, a continuous loading of a stirred vessel with a monomer mixture consisting of styrene, α-methylstyrene and acrylic acid and the simultaneous removal of the polymer. A range between 170° C. and 300° C. is described as the reaction temperatures. It is readily evident to the person skilled in the art that a polymerization in a continuously operated stirred vessel can take place only incompletely and must lead to a product having high proportions of residual monomers. Furthermore, a process step for working-up or for granulation of the product is not described in EP 0 096 901. In the meantime, tubular reactors have become very important for carrying out a continuous mass polymerization. WO 98/04593 describes the continuous preparation of acrylate resins or copolymers of styrene, α-methylstyrene and acrylic acid. The polymerization is carried out at a temperature between 180° C. and 260° C. The preparation of polymers of analogous composition for dispersing or emulsifier applications in a temperature range between 210° C. and 246° C. is published in U.S. Pat. No. 6,476,170. WO 99/23119 claims the preparation of adhesive resins in a tubular reactor at a polymerization temperature between 100° C. and 300° C.—WO 2005/066216 claims the preparation of hotmelt adhesives at temperatures below 130° C. All products mentioned here are not subject to granulation or similar working-up in the processes described. This corresponds to the customary procedure for products in adhesive or hotmelt adhesive applications, which as a rule are present in waxy or liquid form. Coatings in the form of a lacquer or of a paint are also not mentioned as an application. The same also applies to the polymerization process described in WO 98/12229. This involves a variant of the tubular reactor: the recycle reactor. The aim of the claimed process was the preparation of polymethacrylates for the production of mouldings. Granulation of the products or use in coatings is not described. Moreover, for example, a change of formulation in a continuously operated kneader is associated with substantially less effort than in such a tubular reactor. Moreover, the reaction zone is substantially shorter or the mixing more efficient, and hence the residence time in the reaction space. This in turn can lead to greater thermal loading of the product in such a tubular reactor.

A new generation of reactors for the continuous mass polymerization of (meth)acrylates comprises the so-called Taylor reactors. These reactors, too, can be used in a wide temperature range. A detailed description of a corresponding process for the preparation of binders for coatings or adhesives or sealants is to be found in WO 03/031056. However, these reactors, too, have the disadvantage of poorer mixing and a rather longer residence time.

It is true that WO 03/031056 mentions coatings as a potential application of the process according to the invention. Processing—in particular granulation—after the polymerization is however not mentioned.

An alternative to the continuous loading of reaction reactors is reactive extrusion. WO 2007/087465 presents a process for the continuous preparation of poly(meth)acrylates for adhesive applications. However, a targeted adjustment of the microstructure of the products has not yet been described to date.

Kneader technology is in principle very similar to reactive extrusion. WO 2006/034875 describes a process for the continuous mass polymerization, in particular for the homo- or copolymerization, of thermoplastics and elastomers, above the glass transition temperature in a back-mixing kneading reactor. Monomers, catalysts, initiators, etc. are fed continuously into the reactor and back-mixing with already reacted product. At the same time, reacted product is removed continuously from the mixing kneader. The process can be used, for example, for the continuous mass polymerization of MMA. The unreacted monomer is separated off by means of a devolatilizer and can be recycled to the reactor. Compared with the disadvantageous reactive extrusion with comparable throughputs, substantially higher conversions are achievable with the kneader technology. In order to realize a comparable conversion by means of a reactive extrusion, a substantially longer residence time in the extrusion zone or a substantially lengthened extrusion chamber must be allowed for. However, this leads to higher thermal loading of the material and may have disadvantages, such as discolouration of the product or nonuniform molecular weight distribution.

WO 2007/112901 describes a process for the treatment of viscous products, in particular for carrying out homo- or copolymerization of thermoplastics and elastomers, in which a conversion of 90-98% is achieved. Monomer(s), catalyst(s) and/or initiator(s) and/or chain-transfer agents are fed continuously to a back-mixing kneader or to a kneading reactor and back-mixed with already reacted product, and the reacted product is removed from the mixing kneader. Here, the product in the kneader is heated to a boiling point, parts of the starting materials are vaporized and exothermicity of the process is absorbed by evaporative cooling. This process can be carried out without solvents or only with very small amounts of solvents. The optimum boiling point is set by changing the pressure. The back-mixing is effected until a predetermined viscosity of the product is reached. The viscosity is maintained by continuous addition of the starting materials. Integrated working-up of the product or a process for minimizing fine fractions in the product combined with a continuous mass polymerization in the preparation of binders, for example for coatings, are not described in any of the documents mentioned and are not part of the prior art.

### OBJECT

It was an object of the present invention to provide improved binders based on acrylate or methacrylate ((meth)acrylate for short below) for coating formulations. In particular, it was an object of the present invention to provide (meth)acrylate binders having improved processing properties compared with the prior art. For this purpose, the binder should be present as granules after production and should have a fine or dust fraction, i.e. particles which are smaller than 250 μm, of less than 0.5% by weight. Moreover, the binder should contain no coarse constituents, i.e. particles which are larger than 3 mm.

It was simultaneously an object of the present invention to prepare said binder by means of a continuous preparation process. A continuous preparation process is understood as meaning a process which can be carried out continuously without interruption and which specifically consists of the process steps of monomer metering, polymerization, devolatilization and granulation.

A further object was to provide an environmentally friendly process which can be carried out either in the absence of a solvent or with a maximum proportion of 10% by weight of solvent and which can be carried out with high conversion and with only a very small proportion of residual monomers.

In addition, the binders should have high thermal stability—for example at temperatures of about 214° C. This is to be ensured by a particularly small proportion of head-to-head bonds in the polymer chain.

A further object arose from the requirements for good gloss properties of the binder, such that the process can be carried out without addition of auxiliaries, such as emulsifiers, stabilizers or antifoams.

### Achievement

The objects were achieved by a modified use of a continuous mass polymerization process, with the aid of which (meth)acrylates can be polymerized with high conversion in the absence of a solvent. The advantage of a mass polymerization process over the suspension polymerization is the high purity of the products, which can be prepared without addition of auxiliaries, such as emulsifiers, stabilizers, antifoams or other suspension auxiliaries. A further advantage is the freedom of the product from water. Binders prepared by means of suspension polymerization frequently exhibit poorer gloss properties and sometimes also dispersing properties in coatings. This effect is due not only to the polymer microstructure but also to the process-related residual moisture of the polymer.

A further advantage of mass polymerization over suspension polymerization is the use of any desired amounts of hydrophilic comonomers, such as (meth)acrylic acids or amino- or hydroxyfunctional (meth)acrylates.

The advantage over solution polymerization is the absence or the only very small proportion of volatile constituents in the polymerization process or in the primary product. The advantage of the process according to the invention over a mass polymerization in a batch procedure is the substantially higher achievable conversion and hence the smaller proportion of residual monomers in the end product. A higher production speed and a broader potential variation of the process parameters are additional factors.

A particular advantage of the process according to the invention for the preparation of binders for lacquers or coating materials is the form in which the product is present at the end of the preparation process without further processing. As a result of the combination of a continuously operated kneader for the polymerization, a devolatilization stage, such as, for example, a flash devolatilizer or a devolatilizing kneader for removing volatile constituents or for thermal aftertreatment of the polymer, and of a granulator, products are obtained which firstly are free of solvents, secondly have a water content of less than 1% by weight, thirdly consist exclusively of constituents which are based on the monomers, chain-transfer agents and initiators used and which have an adjustable granule size.

These granules prepared according to the invention have a fine or dust fraction, i.e. particles which are smaller than 250 μm, of less than 0.5% by weight. Dust fractions can be problematic in many respects in the subsequent processing. Particles of such a size may remain attached owing to static charge built-up on various surfaces and thus, for example, lead to blockage of nozzles. Moreover, for example, transfer processes may result in the formation of dust clouds which not only lead to product loss and in particular necessitate respiratory protection measures but additionally carries the danger of dust explosions.

The binder prepared according to the invention furthermore contains no coarse constituents, i.e. particles which are larger than 3 mm. Larger particles not only may lead to blockages, for example of nozzles, but additionally reduce the bulk density. A particular disadvantage of such a coarse material is in particular the reduced solubility rate in organic solvents, plasticizers or water. This is readily evident from a surface/mass ratio which is more unfavourable compared with smaller particles.

The preferred process for achieving the object is the continuously operated kneader technology. A description of such a back-mixing kneading reactor for continuous mass polymerization from List is to be found in WO 2006/034875 or in WO 2007/112901. The polymerization is carried out above the glass transition temperature of the polymer. Monomers, catalysts, initiators, etc. are fed continuously into the reactor and back-mixed with already reacted product. At the same time, reacted product is removed continuously from the mixing kneader. The unreacted monomer is separated off by a devolatilizer for residual material and can be recycled to the reactor. At the same time, the thermal aftertreatment of the polymer is carried out in this devolatilizer for residual material.

A particular aspect of the achievement according to the invention is the possibility of an individual choice of the polymerization temperature as a function of the requirements with regard to the respective product or the respective application. The properties of the binder to be prepared with regard to gloss, thermal stability, dispersing and wetting properties of pigments and processing properties of the binder or of the coating formulation surprisingly depend not only on the composition, the molecular weight, the molecular weight distribution, the functionalities and the terminal groups but in particular also on the microstructure of the polymer chain. In this case, microstructure is understood as meaning the tacticity and the proportion of head-to-head linkages in the chain of the polymer. It is known to the person skilled in the art that a poly(meth)acrylate prepared by a free radical method is, depending on the monomer composition, a copolymer between syndiotactic and atactic segments (triads)—with only a small proportion of isotactic triads. Polymethacrylates having particularly large syndiotactic fractions can be prepared only by means of technically complicated processes, such as anionic polymerization at particularly low temperatures or a metal-initiated group transfer polymerization (GTP) with stereoselective catalysts. Highly isotactic polymers on the other hand can be realised virtually only via the latter method. A third possibility of having a stereoselective influence on a polymerization consists in adding a complexing agent in the form of an optically active reagent to the polymerization solution. In this context, see, for example, EP 1 611 162. However, this procedure has various disadvantages: firstly, it can be used efficiently only in a solution polymerization; secondly, the auxiliary constitutes a further polymerization component which either has to be removed by a complicated procedure or influences the optical properties of the end product.

A further aspect of the coat quality is the gloss. It has already been explained that the gloss is greatly influenced by the water or solvent content in the coating matrix. The major advantage of the continuously operated mass polymerization according to the invention in a kneader over conventional processes, such as solution, suspension or emulsion polymerization, is that it can be carried out without addition of solvents, water or any process auxiliaries, such as emulsifiers, antifoams, stabilizers or dispersants. However, these constituents adversely affect the gloss properties in use.

Surprisingly, however, it was additionally found that the microstructure can also contribute a considerable measureable effect to the gloss values of a coating. Depending on the polymer composition, it was possible to show that polymers having a smaller syndiotactic fraction have improved gloss values compared with suspension polymers considered as standard and prepared at 80° C.

A further aspect of the present invention is the preparation of (meth)acrylate-based binders which have a thermal stability up to 214° C., preferably up to 230° C., very particularly preferably up to 250° C. Thermal stability at a given temperature is understood as meaning a loss of mass of less than 1% by weight in a thermogravimetric analysis (TGA) according to DIN EN ISO 11358. In particular, the polymerization at higher temperatures favours the formation of so-called head-to-head bonds. These bonds in the polymer chain, where two quaternary carbon atoms are linked to one another in the case of poly(meth)acrylates, show thermal instability at temperatures above 150° C. and, on breaking, can initiate the depolymerization of a chain. This leads to a reduced production yield and an increased residual monomer content in the polymer. In addition, such products may exhibit reduced storage or weather stabilities owing to unstable bonds.

The formation of head-to-head bonds in poly(meth)acrylates at higher polymerization temperatures is not only a phenomenon which can be observed in mass polymerization but also occurs in the case of solution polymers which were prepared at a corresponding temperature. In the present invention, the problem of head-to-head bonds and hence of reduced thermal stability was solved by thermally aftertreating the product after the polymerization was complete. At a temperature above 120° C., preferably above 160° C., particularly preferably above 180° C., not only can volatile constituents present in the product, such as residual monomers or optionally used solvents, be removed but also the head-to-head bonds are broken and the relevant polymer chains stabilized or depolymerized thereby and the resultant low molecular weight compounds removed. The monomers recovered in this manner can optionally even be recycled to the polymerization process. Such a procedure can be implemented in kneader technology without problems by an associated process step, such as flash devolatilization, a devolatilization kneader or a vented extruder.

In a variant of this process, the thermal decomposition of the head-to-head bonds and the devolatilization take place separately from one another. First, the polymer is transported via a melt tube or a heat exchanger. The thermal aftertreatment takes place there. After, as described above, the volatile constituents, such as the residual monomers, solvent and the volatile constituents formed during the thermal aftertreatment, are removed by means of a devolatilization kneader, vented extruder or flash devolatilizer and the melt is passed on to the granulation.

Monomers which are polymerized are selected from the group consisting of the (meth)acrylates, such as, for example, alkyl (meth)acrylates of straight-chain, branched or cycloaliphatic alcohols having 1 to 40 carbon atoms, such as, for example, methyl (meth)acrylate, ethyl (meth)acrylate, n-butyl (meth)acrylate, isobutyl (meth)acrylate, tert-butyl (meth)acrylate, pentyl (meth)acrylate, 2-ethylhexyl (meth)acrylate, stearyl (meth)acrylate, lauryl (meth)acrylate, cyclohexyl (meth)acrylate, isobornyl (meth)acrylate; aryl (meth)acrylates, such as, for example, benzyl (meth)acrylate or phenyl (meth)acrylate, which may have in each case unsubstituted or mono- to tetrasubstituted aryl radicals; other aromatically substituted (meth)acrylates, such as, for example, naphthyl (meth)acrylate; mono(meth)acrylates of ethers, polyethylene glycols, polypropylene glycols or mixtures thereof having 5-80 carbon atoms, such as, for example, tetrahydrofurfuryl methacrylate, methoxy(m)ethoxyethyl methacrylate, 1-butoxypropyl methacrylate, cyclohexyloxymethyl methacrylate, benzyloxymethyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol)methyl ether (meth)acrylate and poly(propylene glycol)methyl ether (meth)acrylate. The choice of monomers may also comprise respective hydroxyfunctionalized and aminofunctionalized and/or mercaptofunctionalized and/or olefinically functionalized and/or carboxyl functionalized acrylates or methacrylates, such as, for example, allyl methacrylate or hydroxyethyl methacrylate.

In addition to the (meth)acrylates described above, the compositions to be polymerized may also comprise further unsaturated monomers which are copolymerizable or homopolymerizable with the abovementioned (meth)acrylates. These include, inter alia, 1-alkenes, such as 1-hexene, 1-heptene, branched alkenes, such as, for example, vinylcyclohexane, 3,3-dimethyl-1-propene, 3-methyl-1-diisobutylene, 4-methyl-1-pentene, acrylonitrile, vinyl esters, such as, for example, vinyl acetate, styrene, substituted styrenes having an alkyl substituent on the vinyl group, such as, for example, α-methylstyrene and α-ethylstyrene, substituted styrenes having one or more alkyl constituents on the ring, such as vinyltoluene and p-methylstyrene, halogenated styrenes, such as, for example, monochlorostyrenes, dichlorostyrenes, tribromostyrenes and tetrabromostyrenes; heterocyclic compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, 9-vinylcarbazole, 3-vinylcarbazole, 4-vinylcarbazole, 2-methyl-1-vinylimidazole, vinyloxolane, vinylfuran, vinylthiophene, vinylthiolane, vinylthiazoles, vinyloxazoles and isoprenyl ether; maleic acid derivatives, such as, for example, maleic anhydride, maleimide, methylmaleimide, cyclohexylmaleimide, and dienes, such as, for example, divinylbenzene, and the respective hydroxyfunctionalized and/or aminofunctionalized and/or mercaptofunctionalized and/or olefinically functionalized compounds. Furthermore, these copolymers can also be prepared in such a way that they have a hydroxyl and/or amino and/or mercapto functionality and/or an olefinic functionality in a substituent. Such monomers are, for example, vinylpiperidine, 1-vinylimidazole, N-vinylpyrrolidone, 2-vinylpyrrolidone, N-vinylpyrrolidine, 3-vinylpyrrolidine, N-vinylcaprolactam, N-vinylbutyrolactam, hydrogenated vinylthiazoles and hydrogenated vinyloxazoles.

The free radical initiators usually used, in particular peroxides and azo compounds, serve as polymerization initiators, which as a rule are added to the monomer phase. In certain circumstances, it may be advantageous to use a mixture of different initiators. The amount used is in general in the range from 0.1 and 5 percent by weight, based on the monomer phase. Azo compounds, such as azobisisobutyronitrile, 1,1′-azobis(cyclohexanecarbonitrile) (WAKO® V40), 2-(carbamoylazo)isobutyronitrile (WAKO® V30), or peresters, such as tert-butyl peroctanoate, di(tert-butyl) peroxide (DTBP), di(tert-amyl) peroxide (DTAP), tert-butyl peroxy(2-ethylhexyl)carbonate (TBPEHC) and further peroxides decomposing at a high temperature are preferably used as a free radical initiator. Further examples of suitable initiators are octanoyl peroxide, decanoyl peroxide, lauroyl peroxide, benzoyl peroxide, monochlorobenzoyl peroxide, dichlorobenzoyl peroxide, p-ethylbenzoyl peroxide, tert-butyl perbenzoate or azobis(2,4-dimethyl)valeronitrile.

For adjusting the molecular weight of the polymer formed, up to 8% by weight of one or more chain-transfer agents known per se may also be added in a customary manner to the monomer phase. The following may be mentioned as examples: mercaptans, such as n-butyl mercaptan, n-octyl mercaptan, n-dodecyl mercaptan, tert-dodecyl mercaptan or mercaptoethanol; thioglycolic acid or thioglycolic esters, such as isooctyl thioglycolate or lauryl thioglycolate; aliphatic chlorine compounds; enol ethers or dimeric α-methylstyrene.

If branched polymers are to be prepared, the monomer phase may also contain up to about one percent by weight of polyfunctional monomers, for example ethylene glycol di(meth)acrylate, butanediol di(meth)acrylate or divinylbenzene.

In order to be able to optimally adjust the viscosity in the continuously operated reactor, optionally up to 10% by weight of a solvent or of a plasticizer may be added to the system. At particularly high melt viscosities, such an addition may be necessary in order to ensure optimal thorough mixing of the reaction solution. Preferably not more than 5% by weight are added to the monomer mixture. Particularly preferably, the polymerization is carried out without addition of a solvent or of a plasticizer. There are no limitations in the case of the added substances which can be used. These may be, for example, acetates, aliphatic solvents, aromatic solvents or polyethers or phthalates.

There is a broad field of use for the products prepared according to the invention. The (meth)acrylate-based mass polymers are preferably used in coatings, for example of metal, plastic, ceramic or wood surfaces. An example of a coating material is the use of the polymers according to the invention as binders in paints for structures, marine paints or container paints. The polymers can also be used in road markings, floor coatings, printing inks, heat-sealing lacquers, reactive hotmelt adhesives, adhesive materials or sealants.

The examples shown below are shown for better illustration of the present invention but are not suitable for limiting the invention to the features disclosed herein.

### EXAMPLES

### Particle Sizes

The particle sizes and the particle size distributions which are stated below as a d₅₀ value were determined using a Coulter LS 13 320 according to ISO 13320-1 in a measuring range between 0.04 μm and 2000 μm.

Particle sizes greater than 2000 μm were additionally determined using a Camsizer from Retsch Technology according to ISO/FDISm13322-2.2:2006(E).

### Measurement of the Glass Transition Temperatures

The measurement of the glass transition temperatures is effected by means of dynamic differential thermal analysis (DSC) according to DIN EN ISO 11357-1.

### Measurement of the Dissolution Times

The unchanged products of the example or comparative example synthesis are thermostated in a conditioned chamber for 24 h at 23° C. A dissolver disc having a diameter of 4 cm is mounted on a dissolver (Getzmann VMA model) and the apparatus thermostat is set to 23° C. 90 ml of solvent are initially introduced into the 250 ml double-walled vessel and thermostated over a period of 5 min with gentle stirring. Thereafter 60 g of the polymer sample are added, the cover is immediately closed and the stirrer is set at 1200 revolutions/min. At intervals of 1 min, the cover is opened and a sample is aspirated by means of a glass pipette for optical assessment. It is then released back into the vessel. After 20 min, the measuring intervals are lengthened to 5 min.

As soon as solids or suspended substances are no longer detectable in an optical assessment, the stirrer is removed, the time is noted and the entire sample is optically evaluated as a check. If suspended substances were still detectable, the entire measurement was repeated.

All measurements are carried out five times altogether and stated as a measuring range in the corresponding Table.

### Example E1, Composition 1

### Continuous Mass Polymerization

A mixture consisting of 20% by weight of methyl methacrylate, 80% by weight of n-butyl methacrylate, 0.4% by weight of TBPEHC from Degussa Initiators and 0.4% by weight of ethylhexyl thioglycolate (TGEH) is fed continuously to a back-mixed kneading reactor from List, as described, for example, in WO 2006/034875, and reacted polymer is simultaneously removed continuously from the reactor. The internal temperature in the reactor is 140° C. The average residence time is about 30 minutes. Immediately after the reactor, the polymer melt is transferred via a melt tube, in which head-to-head bonds thermally unstable at 190° C. are broken, into a devolatilization kneader from List, in which remaining unreacted monomers are removed from the polymer at a temperature of 180° C. Between reactor and devolatilization kneader, there is the possibility of taking a sample for TGA measurements. After the devolatilization, the polymer melt is passed on directly into a Compact 120 underwater granulator from BKG GmbH, equipped with a 0.8 mm perforated plate. The granules are then dried in a Master 300 dryer and collected in a suitable vessel and the particle size is determined as described above.

### Reference Example R1, Composition 1

### Suspension Polymerization

3200 ml of demineralized water are initially introduced into a 5 l HWS glass reactor equipped with interMIG impeller and reflux condenser, the impeller is set to a speed of 300 revolutions per minute and heating is effected to an external temperature of 40° C. 200 g of polyacrylic acid and 0.5 g of potassium hydrogen sulphate are added and are distributed by stirring. 1280 g (80%) of n-butyl methacrylate, 320 g (20%) of methyl methacrylate, 7.5 g of Peroxan LP and 4 g of TGEH are mixed in a beaker and homogenized with stirring. The monomer stock solution is pumped into the reactor. The internal temperature is regulated at 85° C. The polymerization is complete when the heat evolution stops. The batch is cooled. The mother liquor is separated from the polymer beads by means of a suction filter. The particle size is determined as described above.

### Example E2, Composition 2

As in example 1, but the mixture fed to the reactor consists of 65% of n-butyl methacrylate, 34% of methyl methacrylate, 1% of methacrylic acid and 0.8% of lauryl mercaptan from Dr. Spiess Chemische Fabrik GmbH. After the devolatilization in the devolatilization kneader, the polymer melt is passed on directly into a microgranulator from BKG GmbH, equipped with a 0.6 mm perforated plate. The granules are then dried and collected and the particle size determined analogously to example E1.

### Example B3, Composition 2

As in example 2 with a changed presetting of the microgranulator hole size by use of a 1.5 mm perforated plate with the aim of obtaining coarser particles.

### Reference Example R2, Composition 2

### Suspension Polymerization

As in reference example 1, but with 510 g of methyl methacrylate, 975 g of n-butyl methacrylate, 15 g of methacrylic acid, 7.5 g of Peroxan LP and 12 g of lauryl mercaptan from Dr. Spiess Chemische Fabrik GmbH.

### Reference Example R3, Composition 2

### Mass Polymerization

10 g of methacrylic acid, 340 g of methyl methacrylate, 650 g of n-butyl methacrylate, 2.5 g of TRIGONOX 21S (from Akzo Nobel) and 3.5 g of lauryl mercaptan from Dr Spiess Chemische Fabrik GmbH are initially introduced between two glass plates which are sealed at the edge with sealing strip and between which the distance is 10 mm. The entire mould is placed in a water bath for 24 h at 40° C. Thermostating is then effected for a further 8 h at 100° C. After cooling, the product is removed from the mould and crushed by means of a mill.

| | | Particle | Particle | Particle | Particle | Particle | Particle |
|---|---|---|---|---|---|---|---|
| | | fraction < | fraction < | fraction < | fraction > | fraction < | fraction > |
| | d₅₀ | 250 μm | 500 μm | 2000 μm | 2000 μm | 3000 μm | 3000 μm |
| E1 | 1788 μm | 0.0% | 0.0% | 80.7% | 9.3% | 100.0% | 0.0% |
| R1 | 455 μm | 7.3% | 62.2% | 99.9% | 0.1% | 100.0% | 0.0% |
| E2 | 646 μm | 0.0% | 8.7% | 100.0% | 0.0% | n.d. | n.d. |
| E3 | 1706 μm | 0.0% | 0.0% | 83.8% | n.d. | 100.0% | 0.0% |
| R2 | 296 μm | 31.6% | 98.4% | 100.0% | 0.0% | n.d. | n.d. |
| R3 | n.d. | n.d. | n.d. | n.d. | n.d. | n.d. | 88% |

The two comparative examples prepared by means of suspension polymerization have relevant fine fractions with 7.3% by weight and 31.6% by weight, respectively, of material having a particle size smaller than 250 μm. The polymers prepared according to the invention on the other hand are free of fine material of this size. At the same time, it is possible, by means of the process according to the invention, to prepare polymer powders which, exactly as the suspension polymers R1 and R2, are free of coarse particles. These constituents would adversely affect the dissolution rate and the processability of a coating.

### Dissolution Times

| | | | | | Glass transition |
|---|---|---|---|---|---|
| | Solvent | d₅₀ | | Dissolution time | temperature T_{g} |
| E1 | MEK | 1788 | μm | 19-25 min | n.d. |
| R1 | MEK | 455 | μm | 8-11 min | n.d. |
| E2 | Xylene | 646 | μm | 15-17 min | 57.6° C. |
| E3 | Xylene | 1706 | μm | 50-55 min | n.d. |
| R2 | Xylene | 296 | μm | 11-14 min | 63.0° C. |
| R3 | Xylene | n.d. | μm | 70-75 min | n.d. |
| R4 | Xylene | <710 | μm | 13-16 min | n.d. |

MEK: Methyl ethyl ketone

Reference example R4 is a sieve fraction from example E2 having a particle size smaller than 710 μm. The comparison with reference example R2 shows that, regarding the dissolution time, no major effects independent of the particle size are to be expected. It is also found that the dissolution times of example E2 in comparison with reference R2 and E1 in comparison with R1 are only 20% to 37% and about 130%, respectively, higher in spite of about twice and, respectively, more than three times the d₅₀ values. On the other hand, there is the major advantage of having no fine fractions in the product as in the case of a suspension polymer and hence, as already mentioned, of being able to ensure substantially better processability.

Through the choice of a suitable perforated plate, it was additionally possible with example E2 to show that, through slight modifications, the process still according to the invention can also be optimized with regard to the product dissolution time—with further avoidance of the formation of coarse or fine fractions.

The advantage over a mass polymer (reference example R3) prepared in a non-continuous manner and milled according to the prior art is to be seen in a three-fold to four-fold dissolution time. Even an example (E3) according to the invention which has been granulated to give particularly large particles shows a still substantially faster solubility.

1. Mass polymerization process for the preparation of a (meth)acrylate-based binder for coating formulations via continuous mass polymerization,
characterized in that
the process a.) is carried out at a reaction temperature which is between 20° C. and 250° C.,
that b.) the monomers are metered in continuously,
that c.) in a continuous process step directly following polymerization, the binder is either thermally aftertreated and subsequently devolatilized or simultaneously thermally aftertreated and devolatilized,
that d.) the binder is granulated in a directly subsequent, fourth, continuous process step,
and that e.) the granulated binder has defined particle sizes with a component of not more than 0.5% by weight of particles which are smaller than 250 μm.

2. Mass polymerization process according to claim 1, characterized in that the continuous polymerization process is a polymerization in a kneader.

3. Mass polymerization process according to claim 1, characterized in that
a.) the binder is prepared from a monomer mixture which consists exclusively of monomers and initiators and optionally chain-transfer reagents and not more than 10% by weight of solvent,
b.) the process is carried out without addition of auxiliaries, such as emulsifiers, stabilizers or antifoams,
and c.) the polymers have a thermal stability of at least 214° C. as a result of a thermal aftertreatment in the process.

4. Mass polymerization process according to claim 1, characterized in that, as a result of a thermal aftertreatment at a temperature of more than 120° C., preferably of more than 160° C., in a device downstream of the reactor,
a.) the binder has a thermal stability up to 214° C. and
that, simultaneously or in a further continuously operated process step directly following the thermal aftertreatment,
b.) volatile constituents are removed from the binder.

5. Mass polymerization process according to claim 1, characterized in that,
as a result of a granulation and without screening, a binder is obtained which
a.) contains no constituents which are larger than 3 mm and
b.) contains not more than 0.5% by weight of constituents which are smaller than 250 μm.

6. Mass polymerization process according to claim 1,
characterized in that the reaction temperature is above 100° C., and that the glass transition temperature is about 2° C. lower than in the case of a polymer with the same composition which was prepared by means of suspension polymerization at 80° C.

7. (Meth)acrylate-based binder for coating materials, which is preparable according to the mass polymerization process in claim 1.

8. (Meth)acrylate-based binder for coating materials according to claim 7, which additionally contains styrene and/or other vinyl compounds capable of free radical polymerization.

9. Use of the binder according to claim 7 in coating formulations for the coating of metal, plastic, ceramic or wood surfaces.

10. Use of the binder according to claim 7, in marine or container paints.

11. Use of the binder according to claim 7 in paints for structures.

12. Use of the binder according to claim 7 in road markings or floor coatings.

13. Use of the binder according to claim 7 in printing inks.

14. Use of the binder according to claim 7 in reactive hotmelt adhesives or heat-sealing lacquers.

15. Use of the binder according to claim 7 in adhesive materials or sealants.
